(19) United States
(12) Patent Application Publication
(10) Pub. No.: US 2009/0019407 A1
(43) Pub. Date: Jan. 15, 2009

(54) CLOCK SUPPLY CIRCUIT AND METHOD OF DESIGNING THE SAME

(75) Inventor: Toru MATSUI, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/167,433

(22) Filed: Jul. 3, 2008

(30) Foreign Application Priority Data
Jul. 10, 2007 (JP) 2007-181420

(51) Int. Cl. G06F 17/50

(52) U.S. Cl. 716/5; 716/10

(57) ABSTRACT

A clock supply circuit according to the present invention has a clock tree structure, supplies a clock signal to operating elements, includes driving elements arranged in levels in the clock tree structure and includes connection lines which connect output terminals of the driving elements either to input terminals of driving elements arranged in levels immediately succeeding the levels of the respective driving elements with which the respective connection lines start or to input terminals of the operating elements with which last ones of the connection lines end, and in the clock supply circuit, the connection lines include first lines formed in a standard wiring layer and at least one second line formed above a circuit block which uses the standard wiring layer, and at least one second line formed above the circuit block is in a predetermined wiring layer higher than the standard wiring layer.

### BACKGROUND OF THE INVENTION

(1) Field of the Invention

The present invention relates to clock supply circuits and methods of designing the same, and in particular to clock supply circuits having a clock tree structure which supply clock signals to several operating elements and the methods of designing the same.

(2) Description of the Related Art

Accompanied by recent segmentation of manufacturing processes, process variation of lines and transistors have a great influence on the performances of a clock supply circuit including the lines and transistors. For example, process variation of lines and transistors lead to the differences in the delay times of clock signals. In general, the delay time td per cell in a level in the clock tree structure can be represented by the following Expression (1):

td=t0+Δt(Cg+Cw)

Here, t0 denotes a delay time independent from load, a coefficient Δt denotes a delay time per unit load capacitance, Cg denotes a gate capacitance of a next-level cell which is a load, and Cw denotes a line capacitance which is a load.

In Expression (1), the delay time t0, the coefficient Δt, and the gate capacitance Cg vary due to process variation of transistors, and the line capacitance Cw varies due to the process variation of the lines. Therefore, in the case where such process variation of the lines and transistors occurs, the delay times of the respective clock signals propagated through the lines and transistors vary. This may result in clock skew greater than expected.

A clock supply circuit using a clock buffer tree (hereinafter referred to as a “clock tree structure”) is known as a conventional clock supply circuit which reduces clock skew (as an example, see Non-patent Reference 1: “HIGH SPEED CMOS DESIGN STYLES”, written by Kerry Bernstein and other six authors).

The clock tree structure is a tree-like structure in which driving elements such as buffers are arranged. A clock signal from a clock generating circuit is applied to an input terminal of the driving element arranged in the highest level in the clock tree structure. Operating elements such as flip flops (FF), memory macros, or the like are connected at the end of the clock tree structure. The clock tree structure structured like this is capable of reducing clock skew.

An H-shaped clock tree structure is known as a clock tree structure which reduces clock skew more greatly than a normal clock tree structure (as an example, see patent Reference 1: Japanese Unexamined Patent Application Publication No. 2003-78014). The H-shaped clock tree structure is a tree-like structure in which lines between driving elements are arranged in H shapes, and includes combined H-shaped sets of lines. The sizes of the H-shaped sets of lines arranged become gradually smaller from the center toward the periphery. More specifically, in the H-shaped clock tree structure, a clock signal from the clock generating circuit is applied to the center of the H-shaped set of lines arranged at the center part of the clock tree structure. At the four ends of the center H-shaped set of lines, driving elements are connected respectively. The output terminals of the respective driving elements are connected to the center of the H-shaped set of lines arranged in the next level. Further, at the four ends of this H-shaped set of lines, driving elements are connected respectively. In other words, each straight line circuit in the H-shaped clock tree structure is branched into two so that both the branch ends of the straight line circuit are connected at the centers of the next-level straight line circuits in order to prevent clock skew.

However, such H-shaped clock tree structure has a problem that driving elements are required to be arranged at positions which are actually unnecessary. A method known in comparison with this is a method of using such H-shaped clock tree structure only for a portion of the clock supply circuit (For example, see Patent Reference 1).

FIG. 1 is a diagram of the structure of a conventional clock supply circuit disclosed in Patent Reference 1. The clock supply circuit 100 shown in FIG. 1 includes driving elements 101 to 104 arranged in levels in the clock tree structure. The driving element 101 is the driving element arranged at the first level in the clock tree structure, and receives a clock signal applied. The respective driving elements 102 to 104 are driving elements arranged in the second to fourth levels in the clock tree structure.

The clock supply circuit 100 shown in FIG. 1 has an H-shaped clock tree structure in the first and second levels, and has a normal clock tree structure in the third and fourth levels. Since such H-shaped clock tree structure is employed only for the higher levels in the clock supply circuit 100, there is no need to arrange driving elements at unnecessary positions, at least in the lower levels in the clock supply circuit 100. Since the clock supply circuit 100 uses the H-shaped clock tree structure for the higher levels, it is capable of reducing clock skew more greatly than the case of using a normal clock tree structure.

However, in the case of manufacturing a clock supply circuit having multi-level lines, the lines in the respective wiring layers are manufactured according to different conditions determined for each wiring layer (these conditions include the thickness of the wiring layer, the width of each line, and the interval between lines). Thus, the degrees and tendencies of the differences in the wiring capacitances Cw vary among the wiring layers.

However, in a conventional clock tree structure, wiring is performed using several wiring layers without taking into account which wiring layer is used for a current clock line. In this case, even when the line lengths in the H-shaped clock tree structure become equal, the results of multiplying Δt and Cw included in Expression (1) may vary among the lines. This may cause differences in the delay times of the clock signals propagated through the clock paths, and may cause clock skew. In other words, the conventional clock supply circuit entails a problem of causing clock skew due to the quality objectives of the lines in the respective wiring layers.

A scheme effective for reducing such clock skew is to reduce the differences in the line capacitances in the clock paths by reducing the kinds of wiring layers used for clock lines. However, forming clock lines in lower wiring layers exclusively makes it impossible to arrange a clock line above a macro. This causes generation of a detour line, resulting in line congestion.

On the other hand, forming clock lines in higher wiring layers exclusively makes it possible to arrange a clock line above a macro, and to reduce the kind of clock wiring layers. In this case, however, there is a need to connect the terminals of driving elements normally arranged in the lower levels and operating elements and the clock lines arranged in the higher levels. Thus, the number of clock wiring resources increases compared to the case of forming clock lines in the lower wiring layers exclusively, and thus line congestion may also be caused.

### SUMMARY OF THE INVENTION

The present invention aims at providing clock supply circuits capable of reducing clock skew caused due to the differences in the quality objectives of the lines in wiring layers while reducing wiring congestion.

In order to achieve the aim, a clock supply circuit according to the present invention is structured to be the clock supply circuit which has a clock tree structure, supplies a clock signal to operating elements, includes driving elements arranged in levels in the clock tree structure and includes connection lines which connect output terminals of the driving elements either to input terminals of driving elements arranged in levels immediately succeeding the levels of the respective driving elements with which the respective connection lines start or to input terminals of the operating elements with which last ones of the connection lines end, and in the clock supply circuit, the connection lines include first lines formed in a standard wiring layer and at least one second line formed above a circuit block which uses the standard wiring layer, and at least one second line formed above the circuit block is in a predetermined wiring layer higher than the standard wiring layer.

In this structure, only the second line arranged above the circuit block which uses the standard wiring layer is formed in a wiring layer other than the standard wiring layer, and the other lines are formed in the standard wiring layer. Since most of the clock lines are formed in the standard wiring layer, it is possible to reduce clock skew caused due to the differences in the quality objectives of the lines in the respective wiring layers. The quality objectives result from process variation in the clock supply circuit. In addition, in the case where a circuit block which uses the standard wiring layer is arranged between a driving element in a current level and either driving elements in the next level or an operating element, the second line is arranged above the circuit block without making a line detour. Thus, the clock supply circuit according to the present invention does not need to make a line detour, and thus is capable of reducing line congestion.

In addition, in the clock tree structure, all connection lines formed in a level in which the second line is formed may have at least one portion formed in the predetermined wiring layer.

In this structure, a wiring layer higher than the standard wiring layer is used for all the clock lines in the same level in which the clock line is arranged to be above the circuit block which uses the standard wiring layer. With this structure, the process variation caused in predetermined wiring layers equally affects all the operating elements in the clock tree structure. Thus, it becomes possible to reduce the differences in line delays caused due to the differences in the quality objectives of the lines arranged in the respective levels in the clock tree structure. Therefore, the clock supply circuit according to the present invention is capable of reducing clock skew caused due to the differences in the quality objectives of the lines in the respective wiring layers.

In addition, the second line may be a connection line formed in a level lower than the middle level in the clock tree structure.

In this structure, it is possible to form lines having shorter line lengths in a wiring layer other than the standard wiring layer by utilizing a tendency that the line lengths of the lines become shorter as the lines are closer to the end of the clock tree structure. With this structure, the clock supply circuit according to the present invention is capable of reducing the differences in the line delays caused due to the differences in the quality objectives of the lines, and reducing clock skew caused due to the differences in the quality objectives of the lines.

In addition, the predetermined wiring layer may be thicker than the standard wiring layer.

In this structure, since the resistance values become lower as the thicknesses of wiring layers become greater, the line delays of the second line and the connection lines included in the same level in which the second line is arranged become small, thereby reducing the transmission time of the clock system including the second line. In addition, thick wiring layers are generally used only for power sources and the like, the amount of normal signal wiring is small in such wiring layers. Therefore, it is possible to reduce line congestion by forming the second lines in a thick layer.

In addition, the number of levels of the driving elements may be the same in all paths, each of the paths starts with a driving element arranged in the highest level in the clock tree structure and ends with the corresponding one of the operating elements, the line lengths of the connection lines may be approximately the same in the respective levels in the paths in the clock tree structure, and the driving performances of the driving elements may be approximately the same in the respective levels in the clock tree structure.

In the clock tree structure structured to be capable of reducing clock skew in this way, it is possible to reduce line congestion and clock skew caused due to the differences in the quality objectives of the lines of the respective wiring layers.

In addition, a method for designing a clock supply circuit according to the present invention is structured to be the method for designing the clock supply circuit which has a clock tree structure, supplies a clock signal to operating elements, and includes: forming, in the case where a connection line for connecting driving elements which is to be arranged in levels in the clock tree structure is formed above a circuit block which uses a standard wiring layer, the connection line in a predetermined wiring layer higher than the standard wiring layer; and forming, in the case where a connection line for connecting driving elements which is to be arranged in levels in the clock tree structure is not arranged above the circuit block which uses the standard wiring layer, the connection line in the standard wiring layer.

In this structure, only the connection line arranged above the circuit block which uses the standard wiring layer is formed in a wiring layer other than the standard wiring layer, and the other lines are formed in the standard wiring layer. Since most of the clock lines are formed in the standard wiring layer, it is possible to reduce clock skew caused due to the differences in the quality objectives of the lines in the respective wiring layers. The quality objectives result from process variation in the clock supply circuit. In addition, in the case where a circuit block which uses the standard wiring layer is arranged between a driving element in a current level and either driving elements in the next level or an operating element, the connection line formed in a wiring layer higher than the standard wiring layer is arranged above the circuit block without making a line detour. Thus, the clock supply circuit according to the present invention does not need to make a line detour, and thus is capable of reducing line congestion.

It should be noted that the present invention can be implemented not only as clock supply circuits and the methods of designing the same but also as a program causing a computer to execute the unique steps included in the methods of designing the clock supply circuits. As a matter of course, such program can be distributed through recording media such as CD-ROMs and communication media such as the Internet.

The present invention can be implemented as clock supply circuits capable of reducing clock skew caused due to the differences in the quality objectives of the lines in wiring layers while reducing wiring congestion.

Further Information about Technical Background to this Application

The disclosure of Japanese Patent Application No. 2007-181420 filed on Jul. 10, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing the structure of a conventional clock supply circuit;

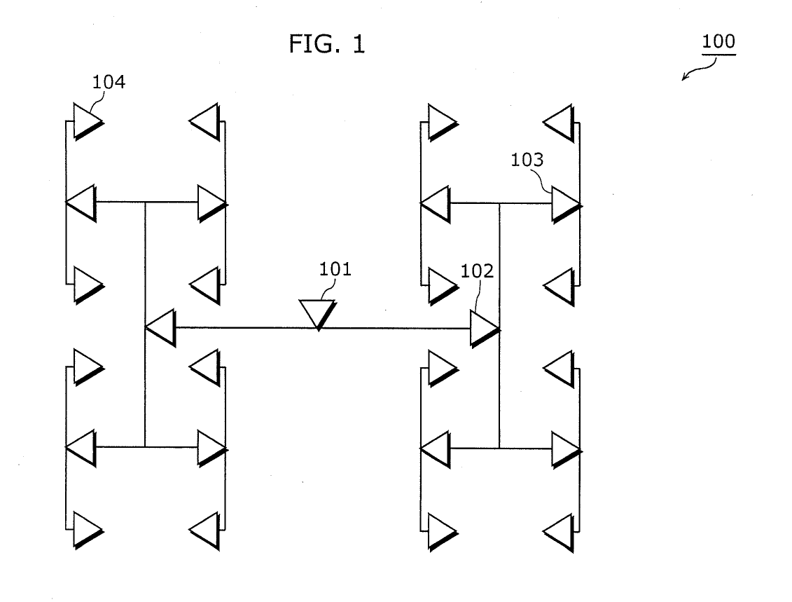

FIG. 2 is a diagram showing the structure of a clock supply circuit of Embodiment 1 according to the present invention;

FIG. 3 is a flowchart illustrating how to design the layout of the clock supply circuit of Embodiment 1 according to the present invention;

FIG. 4 is a diagram showing the structure of a clock supply circuit of Embodiment 2 according to the present invention;

FIG. 5 is a diagram showing the structure of a clock supply circuit of Embodiment 3 according to the present invention;

FIG. 6 is a diagram showing the structure of a clock supply circuit of Embodiment 4 according to the present invention; and

FIG. 7 is a cross-sectional view showing the structure of a clock supply circuit of Embodiment 4 according to the present invention.

### DESCRIPTION OF THE PREFERRED EMBODIMENTS

Descriptions are given of clock supply circuits according to the present invention with reference to the drawings.

### Embodiment 1

In a clock supply circuit having a clock tree structure of Embodiment 1 according to the present invention, among clock lines arranged in levels in the clock tree structure, a clock line arranged above a macro which uses a standard wiring layer is formed in a wiring layer higher than the standard wiring layer, and the other clock lines are formed in the standard wiring layer. The clock supply circuit formed like this is capable of preventing generation of detour lines and reducing clock skew caused due to the differences in quality objectives of the respective wiring layers.

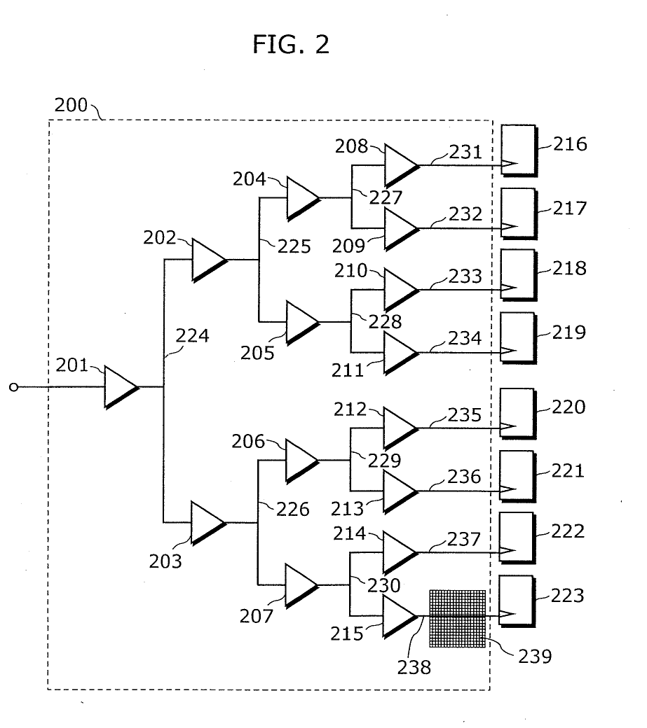

FIG. 2 is a schematic diagram showing the structure of the clock supply circuit of Embodiment 1 according to the present invention.

The clock supply circuit 200 has a clock tree structure, and supplies an inputted clock signal to operating elements 216 to 223. The clock supply circuit 200 is a circuit included in a semiconductor integrated circuit. The clock supply circuit 200 includes driving elements 201 to 215 and lines 224 to 238.

The driving elements 201 to 215 are arranged in a clock tree structure. The driving element 201 is a driving element arranged in the first level which is the highest level in the clock tree structure, and drives a clock signal supplied from an external clock generating circuit or the like.

The driving elements 202 and 203 are driving elements arranged in the second level, and drive the clock signal driven by the driving element 201.

The driving elements 204 to 207 are driving elements arranged in the third level. The driving elements 204 and 205 drive a clock signal driven by the driving element 202. The driving elements 206 and 207 drive a clock signal driven by the driving element 203.

The driving elements 208 to 215 are driving elements arranged in the fourth level. The driving elements 208 and 209 drive a clock signal driven by the driving element 204. The driving elements 210 and 211 drive a clock signal driven by the driving element 205. The driving elements 212 and 213 drive a clock signal driven by the driving element 206. The driving elements 214 and 215 drive a clock signal driven by the driving element 207.

In addition, driving elements arranged in the same level in the clock tree structure have the same driving performance. In other words, the driving elements 202 and 203 have the same driving performance, the driving elements 204 to 207 have the same driving performance, and the driving elements 208 to 215 have the same driving performance.

The operating elements 216 to 223 supply clock signals driven by the respective driving elements 208 to 215. The operating elements 216 to 223 are fillip flops (FFs), memory macros, or the like.

The lines 224 to 238 are lines which connect output terminals of driving elements either to input terminals of driving elements arranged in levels immediately succeeding the levels of the respective driving elements with which the respective connection lines start or to clock input terminals of operating elements with which last ones of the connection lines end.

The line 224 connects an output terminal of the driving element 201 and input terminals of driving elements 202 and 203. The line 225 connects an output terminal of the driving element 202 and input terminals of driving elements 204 and 205. The line 226 connects an output terminal of the driving element 203 and input terminals of driving elements 206 and 207. The line 227 connects an output terminal of the driving element 204 and input terminals of driving elements 208 and 209. The line 228 connects an output terminal of the driving element 205 and input terminals of driving elements 210 and 211. The line 229 connects an output terminal of the driving element 206 and input terminals of driving elements 212 and 213. The line 230 connects an output terminal of the driving element 207 and input terminals of driving elements 214 and 215. The lines 231 to 238 connect the output terminals of the driving elements 208 to 215 and the clock input terminals of the operating elements 216 to 223 respectively.

The lines 224 to 237 are formed in the standard wiring layer. The standard wiring layer is assumed to be the third wiring layer in this embodiment. The standard wiring layer is a wiring layer which is used for a clock line unless any special condition is specified. It should be noted that the standard wiring layer may be a wiring layer other than the third wiring layer. In addition, a standard wiring layer may be specified for each of the X direction and Y direction in the layout of the clock supply circuit 200. For example, the third wiring layer is used as the standard wiring layer for the X-direction wiring, and the fourth wiring layer is used as the standard wiring layer for the Y-direction wiring. For simplification, only the third wiring layer is used as the standard wiring layer. For example, the whole lines 224 to 237 are formed in the standard wiring layer.

The line 238 is formed in a wiring layer higher than the standard wiring layer. For example, the line 238 is formed in the fourth wiring layer. In addition, the line 238 is above a macro 239. It should be noted that the whole line 238 may be formed: in the fourth wiring layer; or a portion of the line 238 which is to be approximately above the macro 239 may be formed in the fourth wiring layer, and most portion of the line 238 may be formed in the standard wiring layer. In other words, it is only necessary that some portion of the line 238 which is to be approximately above the macro 239 is formed in a wiring layer higher than the standard wiring layer. It should be noted that forming some portion of the line 238 approximately above the macro 239 in the fourth layer reduces the portion of the line 238 in wiring layers other than the standard wiring layer, which makes it possible to reduce wiring delay differences caused due to the differences in quality objectives of the respective wiring layers.

In addition, the lengths of connection lines are approximately the same in the respective levels in the paths in the clock tree structure. Here, each of the paths starting with a driving element arranged in the highest level in the clock tree structure and ending with a corresponding one of the operating elements. This is described below in detail. A connection line 224 starting with an output terminal of the driving element 201 is branched into two branched lines one of which ends with an input terminal of the driving element 202 and the other ends with an input terminal of the driving element 203, and both of the branched lines have the same line length. A connection line 225 starting with an output terminal of the driving element 202 is branched into two branched lines one of which ends with an input terminal of the driving element 204 and the other ends with an input terminal of the driving element 205, and both of the branched lines have the same line length. A connection line 226 starting with an output terminal of the driving element 203 is branched into two branched lines one of which ends with an input terminal of the driving element 206 and the other ends with an input terminal of the driving element 207, and both of the branched lines have the same line length. The connection line 225 and the connection line 226 have the same line length. A connection line 227 starting with an output terminal of the driving element 204 is branched into two branched lines one of which ends with an input terminal of the driving element 208 and the other ends with an input terminal of the driving element 209. A connection line 228 starting with an output terminal of the driving element 205 is branched into two branched lines one of which ends with an input terminal of the driving element 210 and the other ends with an input terminal of the driving element 211. A connection line 229 starting with an output terminal of the driving element 206 is branched into two branched lines one of which ends with an input terminal of the driving element 212 and the other ends with an input terminal of the driving element 213. A connection line 230 starting with an output terminal of the driving element 207 is branched into two branched lines each of which ends with an input terminal of the driving element 214 and the other ends with an input terminal of the driving element 215. All of the connection lines 227, 228, 229, and 230 have the same line length. The lines 231 to 238 have the same line length.

In addition, the number of levels of the driving elements starting with the driving element 201 arranged in the first level (the highest level) in the clock tree structure and ending with the driving elements directly leading to the respectively corresponding operating elements 216 to 223 is equally four.

A macro 239 is a circuit block having a predetermined function, and uses the third wiring layer. The macro 239 is arranged between the driving element 215 and the operating element 223.

It is assumed that the input and output terminals of the respective driving elements 201 to 215 and the input terminals of the respective operating elements 216 to 223 are formed in the standard wiring layer. In other words, the lines 224 to 238 do not include via contacts and the like for connecting the standard wiring layer and the lower wiring layers in which the driving elements 201 to 215 and operating elements 216 to 223 are formed.

As described above, lines 224 to 238 for connecting the respective elements in all the levels and connecting the driving elements 208 to 215 in the last level and operating elements 216 to 223 respectively are formed in the clock supply circuit 200 of Embodiment 1 according to the present invention, and the lines 224 to 237 among the lines 224 to 238 are formed in the standard wiring layer because a macro 239 which uses the standard wiring layer is not arranged below the lines 224 to 237 and the line 238 is formed in the fourth layer formed on the third layer which is the standard wiring layer because the macro 239 is arranged below the line 238.

Since most of the connection lines 224 to 238 (for example, a half or more, desirably 90 percent or more) is formed in the standard wiring layer, it is possible to reduce delay amount differences caused due to the differences in the quality objectives of the lines formed in the wiring layers in the respective wiring paths starting with the input terminal of the driving element 201 and ending with the respective operating elements 216 to 223. Thus, the clock supply circuit 200 according to the present invention is capable of reducing clock skew.

In addition, in the clock supply circuit 200 of Embodiment 1 according to the present invention, the wiring layer higher than the standard wiring layer is used for the line 238 which connects the driving element 215 and the operating element 223 between which the macro 239 using the standard wiring layer is arranged. This enables arrangement of the line 238 above the macro 239, which prevents generation of a detour circuit.

The following describes an example of delay amount differences caused due to the differences in the quality objectives of the respective wiring layers generated in the case where the forth layer is used for the line 238.

This delay amount differences can be calculated from the ratio of a sum of a delay amount of the driving element 215 and a delay amount of the line 238 (hereinafter, the sum is referred to as the delay amount of Path B) with respect to a delay amount of a path starting with the driving element 201 and ending with the operating element 223 (hereinafter, this path is referred to as Path A, and this delay amount is referred to as the delay amount of Path A).

For example, when the delay amount of Path A is 1 ns and the delay amount of Path B is 0.2 ns, the ratio of the delay amount of Path B with respect to the delay amount of Path A is 20 percent. Therefore, the delay amount differences in the fourth wiring layer with respect to the delay amount of Path A affect the 20-percent portion of the whole clock delay. In this case, taking into account, for the 20-percent portion, the influence of the differences in the quality objectives of the lines in the wiring structure makes clear the value of a timing margin which should be considered.

Suppose that there is a 5-percent difference in the quality objectives of the lines in each wiring layer, the value of a timing margin to be considered can be obtained as shown below.

$$Delay amount of Path A \times 20 ( \% ) \times 5 ( \% ) = Delay amount of Path A \times 1 ( \% ) = 10 ps$$

In other words, it is possible to secure a sufficient timing margin against clock skew caused due to the differences in the quality objectives of the clock lines by taking into account a margin of 0.01 ns to a timing restriction for the operating element which communicates data between the operating element 223.

Strictly speaking, the value of a difference in the quality objectives of the clock lines in each layer in the above case cannot be uniquely determined because the value varies depending on other factors such as the length of the fourth wiring layer used. For simplification, it is assumed here that a 5-percent difference is generated in each wiring layer used in addition to the standard wiring layer.

Next, a description is given of a method for designing the clock supply circuit 200 of Embodiment 1 according to the present invention.

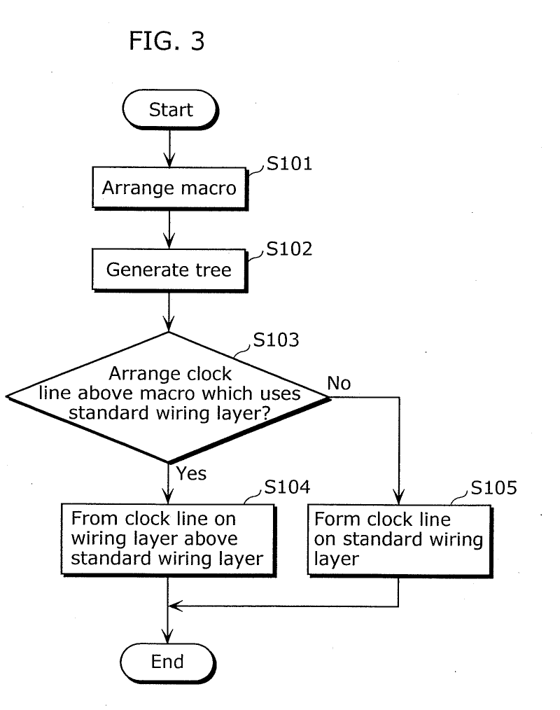

FIG. 3 is a flowchart illustrating how to design the layout of the clock supply circuit 200.

First, the operating elements 216 to 223 and macros including the clock generating circuit which generates a clock used by the operating elements 216 to 223 are arranged based on a netlist generated through a logic synthesis (Step S01). Next, a clock tree structure is generated based on the netlist (Step S102). In other words, based on the arrangement relationship between the clock generating circuit and the respective operating elements 216 to 223, the driving elements 201 to 215 and the lines 224 to 238 are formed so that the number of levels become equal and the length of the lines starting with the clock generating circuit and ending with the respective operating elements 216 to 223 become equal.

Next, whether or not the respective lines 224 to 238 are formed above a macro which uses the standard wiring layer is judged (Step S103). In the case where the judgment shows that a current line among the lines 224 to 238 is formed above the macro which uses the standard wiring layer (Yes in Step S103), the current line is determined to be formed in a wiring layer higher than the standard wiring layer (Step S104). In the opposite case where the judgment shows that a current line among the lines 224 to 238 is not formed above the macro which uses the standard wiring layer (No in Step S103), the current line is determined to be formed in the standard wiring layer (Step S105).

In this way, the layout of the clock supply circuit 200 as shown in FIG. 2 is generated.

It should be noted that the method for designing the clock supply circuit 200 is used when designing the layout using Computer Aided Design (CAD) embedded in a general computer system. For example, the processes shown in FIG. 3 are implemented by a program installed in such general computer system including a processor and a memory. It should be noted that the program may be stored in recording media such as magnetic discs and CD-ROMs. Some or all of the processes shown in FIG. 3 may be implemented by a dedicated hardware circuit, or may be executed by the designer of the clock supply circuit 200.

As described above, the clock supply circuit 200 of Embodiment 1 according to the present invention uses the wiring layer higher than the standard wiring layer only for the output lines of some of the driving elements. Since most of the clock lines are formed in the standard wiring layer, it is possible to reduce wiring delay differences caused due to the differences in the quality objectives of the respective wiring layers. Therefore, the clock supply circuit 200 is capable of reducing clock skew caused due to the differences in the quality objectives of the respective wiring layers.

In addition the clock supply circuit 200 of Embodiment 1 according to the present invention uses the wiring layer higher than the standard wiring layer for clock lines which are required to be formed above the macro which uses the standard wiring layer. With this wiring layout, the clock supply circuit 200 does not have to detour around the clock lines, and thus it becomes possible to reduce wiring congestion.

Embodiment 1 according to the present invention describes the clock supply circuit 200, but the present invention is not limited to Embodiment 1.

For example, in FIG. 2, the macro 239 is assumed to be a macro which uses the wiring layers up to the third layer, but any wiring layer may be used by the macro as long as the macro uses wiring layers higher than the standard wiring layer. For example, in the case where the macro 239 uses the fourth layer, the line 238 is formed in the fifth wiring layer.

In FIG. 2, the macro 239 is arranged below the line 238 in the last level in the clock tree structure, and only the line 238 is formed in a wiring layer higher than the standard wiring layer. However, in the case where the macro 239 is arranged below any one of the lines 224 to 238, it is only necessary that the line above the macro 239 is formed in a wiring layer higher than the standard wiring layer. Further, in the case where a macro which uses the standard wiring layer is arranged below each of several lines, it is only necessary that each line above the macro is formed in a wiring layer higher than the standard wiring layer.

In addition, while the clock tree structure shown in FIG. 2 is structured to have the same length of lines and the same number of element levels, the same advantageous effect can be obtained even if the clock tree structure is structured differently. The respective driving elements may have different driving performances.

The present invention may be applied to a clock supply circuit having an H-shaped clock tree structure.

It is assumed that all the lines 224 to 237 are formed in the standard wiring layer in the above description, but some of the lines 224 to 237 may be formed in another wiring layer. For example, in the case where either the input terminals and output terminals of driving elements or the clock input terminals of operating elements are formed in a wiring layer lower than the standard wiring layer, the respective lines 224 to 237 are required to include the following connection portions: the connection portions for connecting the standard wiring layer which is used for the clock lines either to the input terminals and output terminals of the driving elements or to the clock input terminals of the operating elements. The remaining portion of each of these lines 224 to 237 is referred to as a wiring area which is substantially available as the line. Thus, it is only necessary that the wiring areas are formed in the standard wiring layer, while it is desirable that the wiring areas cover 90 percent or more of the whole lines 224 to 237 in the standard wiring layer. It should be noted that in the case where either the input terminals and output terminals of driving elements or the clock input terminals of operating elements are formed in a wiring layer lower than the standard wiring layer, all the terminals have approximately the same conditions, and thus the influence of delay amount differences caused due to the differences in the quality objectives of the respective wiring layers can be ignored.

The same is true of also in the case where a standard wiring layer is specified for each of the X direction and Y direction in the layout of the clock supply circuit 200. In this case, the combination of the X-direction standard wiring layer and the Y-direction standard wiring layer is regarded as the standard wiring layer in the above description. This case requires via contacts for connecting the X-direction standard wiring layer and the Y-direction standard wiring layer. However, since via contacts are formed in substantially all systems in the clock tree structure and all the clock lines have approximately the same conditions, the influence of delay amount differences caused due to the differences in the quality objectives of the via contacts between these standard wiring layers can be ignored.

### Embodiment 2

A clock supply circuit 300 of Embodiment 2 according to the present invention uses a wiring layer higher than a standard wiring layer, for all clock lines in the same level as the level for which a wiring layer higher than the standard wiring layer is used. This reduces generation of clock skew caused due to the differences in the quality objectives of wiring layers.

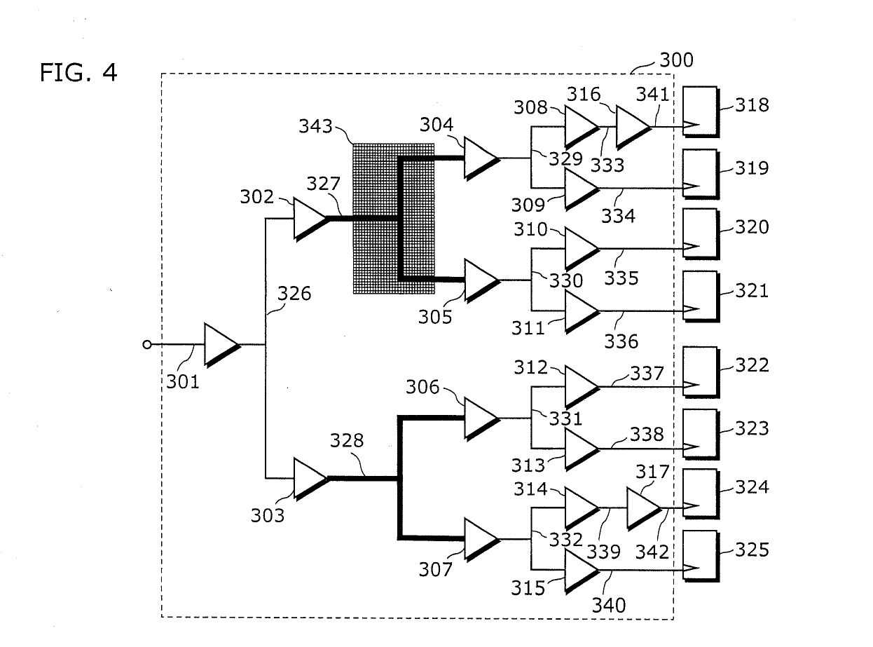

FIG. 4 is a schematic diagram showing the structure of the clock supply circuit 300 of Embodiment 2 according to the present invention.

The clock supply circuit 300 shown in FIG. 4 has a clock tree structure, and supplies an inputted clock signal to driving elements 318 to 325. The clock supply circuit 300 is a circuit included in a semiconductor integrated circuit. The clock supply circuit 300 includes driving elements 301 to 317 and lines 326 to 342.

The driving elements 301 to 317 have a clock tree structure. The driving element 301 is a driving element arranged in the first level which is the highest level in the clock tree structure, and drives a clock signal supplied from an external clock generating circuit or the like. The driving elements 302 and 303 are driving elements arranged in the second level, and drive the clock signal driven by the driving element 301.

The driving elements 304 to 307 are driving elements arranged in the third level. The driving elements 304 and 305 drive a clock signal driven by the driving element 302. The driving elements 306 and 307 drive a clock signal driven by the driving element 303.

The driving elements 308 to 315 are driving elements arranged in the fourth level. The driving elements 308 and 309 drive a clock signal driven by the driving element 304. The driving elements 310 and 311 drive a clock signal driven by the driving element 305. The driving elements 312 and 313 drive a clock signal driven by the driving element 306. The driving elements 314 and 315 drive a clock signal driven by the driving element 307. The driving element 316 drives a clock signal driven by the driving element 308. The driving element 317 drives a clock signal driven by the driving element 314.

The operating elements 318 to 325 supply clock signals driven by the respective driving elements 316, 309 to 313, 317, and 315. The operating elements 318 to 325 are fillip flops (FFs), memory macros, or the like.

The lines 326 to 342 are lines which connect the output terminals of driving elements either to input terminals of driving elements arranged in levels immediately succeeding the levels of the respective driving elements with which the respective connection lines start or to clock input terminals of operating elements with which last ones of the connection lines end.

The line 326 connects an output terminal of the driving element 301 and input terminals of the driving elements 302 and 303. The line 327 connects an output terminal of the driving element 302 and input terminals of the driving elements 304 and 305. The line 328 connects an output terminal of the driving element 303 and input terminals of the driving elements 306 and 307. The line 329 connects an output terminal of the driving element 304 and input terminals of the driving elements 308 and 309. The line 330 connects an output terminal of the driving element 305 and input terminals of the driving elements 310 and 311. The line 331 connects an output terminal of the driving element 306 and input terminals of the driving elements 312 and 313. The line 332 connects an output terminal of the driving element 307 and input terminals of the driving elements 314 and 315. The lines 334 to 338 and 340 connect the output terminals of the driving elements 309 to 313 and 315 and the clock input terminals of the operating elements 319 to 323 and 325 respectively in the listed order. The lines 333 and 339 connect the output terminals of the driving elements 308 and 314 and the input terminals of the driving elements 316 and 317 respectively in the listed order. The lines 341 and 342 connect the output terminals of the driving elements 316 and 317 and the clock input terminals of the operating elements 318 to 324 respectively in the listed order.

The lines 326 and 329 to 342 are formed in the standard wiring layer. The standard wiring layer is assumed to be the third wiring layer in this embodiment. It should be noted that the standard wiring layer may be a wiring layer other than the third wiring layer. In addition, a standard wiring layer may be specified for each of the X direction and Y direction in the layout of the clock supply circuit 300. For simplification, only the third wiring layer is used as the standard wiring layer. For example, the whole lines 326 and 329 to 342 are formed in the standard wiring layer.

The lines 327 and 328 are formed in a wiring layer higher than the standard wiring layer. For example, the whole lines 327 and 328 are formed in the fourth wiring layer. In addition, the line 327 is arranged above a macro 343. It should be noted that the whole line 327 may be formed: in the fourth wiring layer; or a portion of the line 327 which is to be approximately above the macro 343 may be formed in the fourth wiring layer and the other portion of the line 327 may be arranged in the standard wiring layer. In addition, some portion of the line 328 is formed in the fourth layer so that the portion of the line 328 has approximately the same line length as that of the line 327 formed in the fourth wiring layer. In other words, the other portion of the line 328 is formed in the standard wiring layer so that the line length of the line 328 formed in the standard wiring layer is approximately the same as that of the line 327 formed in the standard wiring layer.

In addition, forming, for paths, wiring areas having the same line length in the fourth wiring layer makes it possible to further reduce wiring delay differences. Examples for this include: a case where the line 327 starting with the driving element 302 is branched into two branched lines one of which ends with the driving element 304 and the other ends with the driving element 305, and both of the branched lines have the same line length; and a case where the line 328 starting with the driving element 303 is branched into two branched lines one of which ends with the driving element 306 and the other ends with the driving element 307, and both of the branched lines have the same line length.

A macro 343 is a circuit block having a predetermined function, and uses the third wiring layer. The macro 343 is arranged between the driving element 302 and operating elements 304 and 305.

As described above, line 327 arranged above the macro 343 and the line 328 in the same level as that of the line 327 are formed in a wiring layer higher than the standard wiring layer. In addition, in the case where no line is arranged above the macro 343 which uses the standard wiring layer within the same level, all the lines included in the level are formed in the standard wiring layer. In other words, in the clock supply circuit 300 of Embodiment 2 according to the present invention, all the lines are formed in the standard wiring layer, or are formed in a wiring layer higher than the standard wiring layer.

It is assumed that the input terminals and output terminals of the driving elements 301 to 317 and the clock input terminals of the operating elements 318 to 325 do not include via contacts and the like for connecting the standard wiring layer and the lower wiring layer used for the driving elements 301 to 317 and the operating elements 318 to 325.

As described above, the clock supply circuit 300 of Embodiment 2 according to the present invention is structured so that the line 327 arranged above the macro 343 which uses the standard wiring layer and the line 328 arranged in the same level as that of the line 327 in the clock tree structure are formed in a wiring layer higher than the standard wiring layer. In the clock supply circuit 300 structured in this way, the same wiring layer is used for the lines in the same level in the clock tree structure. Thus, it is possible to reduce the influence of clock skew caused due to the differences in the quality objectives of the respective lines.

Next, a description is given of a method for designing the clock supply circuit 300 of Embodiment 2 according to the present invention. It should be noted that the processes of Steps S101 to S103 and S105 in FIG. 3 are the same as those in Embodiment 1, and thus the same descriptions are not repeated here.

In the method for designing the clock supply circuit 300, in the case where a current line is arranged above a macro which uses the standard wiring layer, (Yes in Step S103), it is determined that the current line and the lines in the same level as that of the current line are formed in a wiring layer higher than the standard wiring layer. In this way, the layout of the clock supply circuit 300 as shown in FIG. 4 is generated.

As described above, the clock supply circuit 300 of Embodiment 2 according to the present invention is capable of reducing clock skew caused due to the differences in the quality objectives of wiring layers while reducing wiring congestion, likewise the clock supply circuit 200 of Embodiment 1.

Further, the clock supply circuit 300 of Embodiment 2 according to the present invention uses the wiring layers higher than the standard wiring layer for clock lines which are required to be arranged above the macro which uses the standard wiring layer. This wiring layout eliminates delay time differences caused due to the differences in the quality objectives of the lines arranged in levels in the clock tree structure. Therefore, the clock supply circuit 300 of Embodiment 2 according to the present invention is capable of reducing clock skew caused due to the differences in the quality objectives of the lines arranged in the respective wiring layers.

In FIG. 4, the macro 343 is assumed to be a macro which uses the wiring layers up to the third wiring layer, but any wiring layer may be used by the macro as long as the macro uses wiring layers higher than the standard wiring layer.

In FIG. 4, the macro 343 is arranged below the line 327 in the second level in the clock tree structure, and the lines 327 and 328 in the second level are formed in a wiring layer higher than the standard wiring layer. However, in the case where the macro 343 is arranged below any one of the lines 326 to 342, it is only necessary that the current line and all the lines in the same level as that of the current line are formed in a wiring layer higher than the standard wiring layer.

The clock tree structure in FIG. 4 is structured so as not to have the same length of lines and the same number of element levels, but the clock tree structure may be structured to have the same.

The present invention may be applied to a clock supply circuit having an H-shaped clock tree structure.

In the above description, the whole lines 326, and 329 to 342 are formed in the standard wiring layer, but another wiring layer may be used for some portion of the lines 326, and 329 to 342, because of the same reason as described in Embodiment 1. A standard wiring layer may be specified for each of the X direction and Y direction in the layout of the clock supply circuit 300.

### Embodiment 3

A clock supply circuit of Embodiment 3 according to the present invention uses a wiring layer higher than a standard wiring layer, for clock lines in succeeding levels in a clock tree structure. This can reduce the length of lines for which the wiring layer higher than the standard wiring layer is used, and thus can reduce clock skew caused due to the differences in the quality objectives of the respective wiring layers.

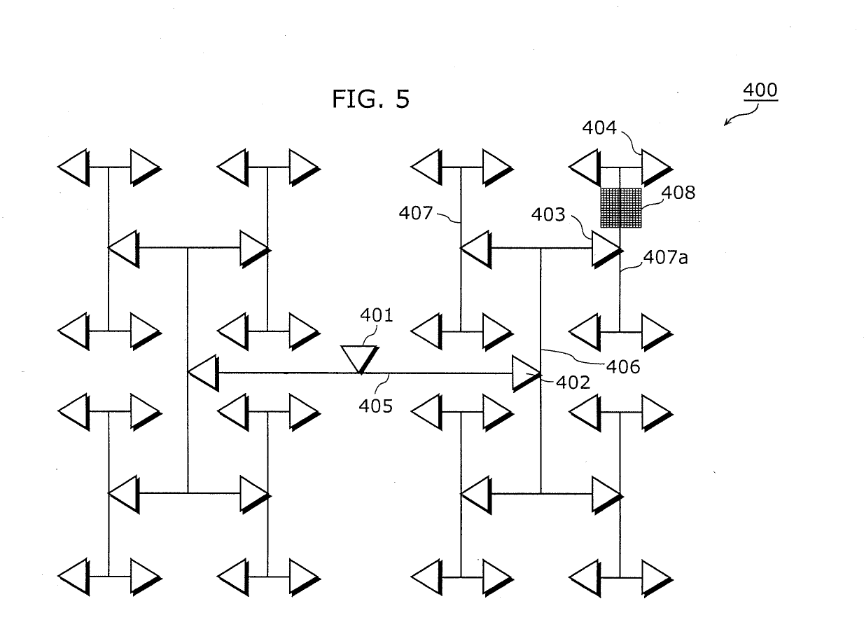

FIG. 5 is a schematic diagram showing the structure of a clock supply circuit of Embodiment 3 according to the present invention.

The clock supply circuit 400 shown in FIG. 5 is a clock supply circuit having an H-shaped clock tree structure. The clock supply circuit 400 includes driving elements 401 to 404 and lines 405 to 407.

The driving element 401 is the driving element arranged in the first level which is the highest level in the clock tree structure, and drives a clock signal supplied from an external clock generating circuit or the like. The driving elements 402 are driving elements arranged in the second level which is next to the highest level, and drive the clock signal driven by the driving element 401. The driving elements 403 are driving elements arranged in the third level, and drive the clock signal driven by the driving element 402. The driving elements 404 are driving elements arranged in the fourth level, and drive the clock signal driven by the driving element 403. The clock signal driven by the driving elements 404 are supplied to the respectively corresponding operating elements (not shown).

The line 405 connects the output terminal of the driving element 401 in the first level and the input terminals of the driving elements 402 in the second level in the clock tree structure. The line 406 connects the output terminals of the driving elements 402 in the second level and the input terminals of the driving elements 403 in the third level in the clock tree structure. The line 407 connects the output terminals of the driving elements 403 in the third level and the input terminals of the driving elements 404 in the fourth level in the clock tree structure. It should be noted that the line 407a shown in FIG. 5 is a portion of the line 407 in the fourth level.

The lines 405 and 406 are formed in the standard wiring layer. In addition, the line 407 other than the line 407a is formed in the standard wiring layer. The third wiring layer is assumed to be the standard wiring layer also in Embodiment 4, although a wiring layer other than the third layer may be the standard wiring layer. A standard wring layer may be specified for each of the X-direction and Y-direction in the layout of the clock supply circuit 400.

The line 407a is formed in a wiring layer higher than the standard wiring layer. For example, the line 407a is formed in the fourth wiring layer. It should be noted that the whole line 407a may be formed: in the fourth wiring layer; or a portion of the line 407a which is to be approximately above the macro 408 may be formed in the fourth wiring layer while most portion of the line 407a is arranged in the standard wiring layer.

A macro 408 is a circuit block having a predetermined function, and uses the third wiring layer. The macro 408 is arranged below the line 407a.

Here, as shown in FIG. 5, the line lengths of the lines 405 to 407 different depending on the levels in the H-shaped clock tree structure. More specifically, the line lengths of lines become shorter as the levels of the lines become lower because the clock tree structure is structured so that the respective lines are started with a single driving element and ended with a number of operating elements. In other words, the line length of the line 407 is shorter than the line length of the line 406, and the line length of the line 406 is shorter than the line length of the line 405.

Since the line lengths become shorter as the wiring capacitances become smaller, the results of multiplying Δt and Cw included in the above expression (1) become smaller as the wiring capacitances become smaller. In other words, it is possible to reduce the influence of delay amount differences on the whole clock system by using a wiring layer higher than the standard wiring layer for the lines having the shortest line length arranged in the lowermost level in the clock tree structure, and to reduce clock skew caused due to the differences in the quality objectives of the respective lines.

As described above, the clock supply circuit 400 of Embodiment 3 according to the present invention can provide the same advantageous effect as in the case of the clock supply circuit 200 of Embodiment 1. Further, the clock supply circuit 400 is capable of further reducing clock skew caused due to the differences in the quality objectives of the lines in the case where it is structured so that the lines at the end of the clock tree structure are formed in a wiring layer higher than the standard wiring layer.

The macro 408 is arranged below the lines in the third level, but it should be noted that the macro 408 may be arranged below the lines (which connect the driving elements 404 and the corresponding operating elements) in the fourth level.

The number of levels in the clock tree structure is not limited to four. The clock supply circuit 400 is capable of providing an advantageous effect of reducing the amount of clock skew in the case where it is structured so that a wiring layer higher than the standard wiring layer is used for the lines in the levels succeeding the middle level in the clock tree structure. For example, in the case where a clock tree structure is structured to have six levels, it is only necessary that a wiring layer higher than the standard wiring layer is used for the fourth and the succeeding levels. It is possible to enhance the advantageous effect by using a wiring layer higher than the standard wiring layer for lines arranged in the levels closer to the end.

In FIG. 5, the clock supply circuit 400 having an H-shaped clock tree structure is shown as an example, but it should be noted that a clock supply circuit having a clock tree structure other than the H-shaped one may be used instead. The same tendency that the line lengths become shorter as the lines become closer to the end of the clock tree structure is true of also in a clock tree structure having a shape other than the H-shape. Therefore, the clock tree structure having another shape is also capable of providing the advantageous effect of reducing clock skew.

### Embodiment 4

A clock supply circuit of Embodiment 4 according to the present invention is structured so that a clock line arranged above a macro which uses a standard wiring layer is formed in a wiring layer having a thickness greater than that of the standard wiring layer and higher than the standard wiring layer. This makes it possible to reduce clock skew caused due to the differences in the quality objectives of the wiring layers.

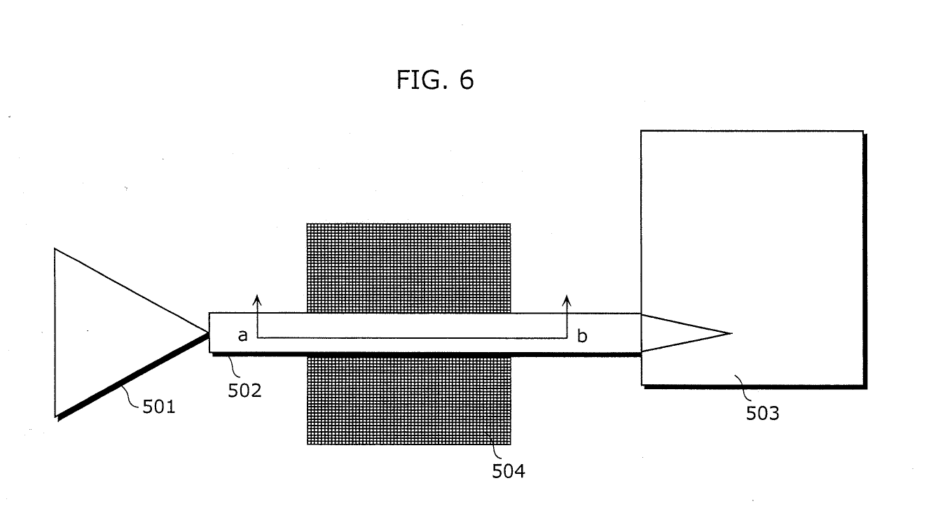

FIG. 6 is a diagram showing the structure of a line formed in a wiring layer higher than the standard wiring layer in the clock supply circuit of Embodiment 4 according to the present invention. It should be noted that the basic structure of the clock supply circuit of Embodiment 4 is the same as, for example, the one shown in FIG. 2.

As shown in FIG. 6, a line 502 connects the output terminal of a driving element 501 in the last level in the clock tree structure and the clock input terminal of the operating element 503. The macro 504 is a macro which uses the standard wiring layer, and is arranged below the line 502.

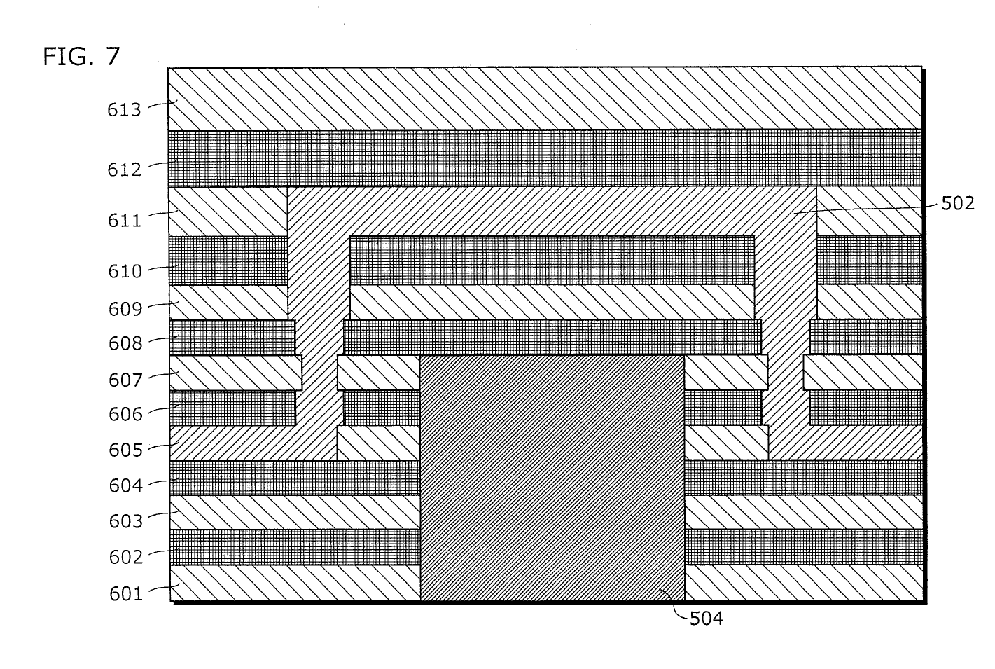

FIG. 7 is a cross-sectional view of the clock supply circuit of Embodiment 4 assuming that it is cut along the a-b surface shown in FIG. 6.

As shown in FIG. 7, the clock supply circuit of Embodiment 4 includes: a first wiring layer 601, a first inter-layer film 602, a second wiring layer 603, a second inter-layer film 604, a third wiring layer 605, a third inter-layer film 606, a fourth wiring layer 607, a fourth inter-layer film 608, a fifth wiring layer 609, a fifth inter-layer film 610, a sixth wiring layer 611, a sixth inter-layer film 612, and a seventh wiring layer 613.

In Embodiment 4, the standard wiring layer is the third wiring layer. The sixth wiring layer 611 and the seventh wiring layer 613 are thicker than the third wiring layer 605, the fourth wiring layer 607, and the fifth wiring layer 609.

The macro 504 is a macro which uses wiring layers up to the fourth wiring layer.

As shown in FIG. 7, most portion of the line 502 is formed in the third wiring layer 605 which is the standard wiring layer while the remaining portion of the line 502 which is to be approximately above the macro 504 is formed in the sixth wiring layer 611. Around the macro 504, the portion of the line 502 formed in the standard wiring layer and the portion of the line 502 formed in the sixth layer are connected to the fourth wiring layer 607, the fifth wiring layer 609, and the respective inter-layer films through via contacts.

The clock supply circuit of Embodiment 4 according to the present invention structured like this is capable of providing the same advantageous effect as in the case of clock supply circuit 200 of Embodiment 1.

Further, the clock supply circuit of Embodiment 4 uses the sixth wiring layer 611 thicker than the standard wiring layer, for the line 502 arranged above the macro 504 which uses the standard wiring layer. This makes it easier to reduce clock propagation time because the resistance values of lines become lower as the thicknesses of the wiring layers become greater. This reduces the delay amount of the line 502, and thus reduces the relative differences in the delay amounts caused when different wiring layers are used. Therefore, the clock supply circuit of Embodiment 4 is capable of further reducing clock skew caused due to the differences in the quality objectives of the respective wiring layers.

The amount of normal signal wiring in such thick wiring layers is small because thick wiring layers are generally used only for power sources and the like. Thus, it is possible to reduce wiring congestion by using thick wiring layers, and reduce wiring congestion in the lower wiring layers.

In the case of using the sixth wiring layer 611 for the line 502, the fourth wiring layer 607 and the fifth wiring layer 609 are used in addition to the third wiring layer 605 which is the standard wiring layer. These portions are connected in a substantially vertical direction, and thus are very slightly affected by the process variation of the respective wiring layers.

In FIG. 7, the sixth wiring layer 611 is used for the line 502, but the seventh wiring layer 613 may be used instead.

FIG. 7 illustrates an example where the macro 504 is arranged between the driving element 501 and operating element 503 in the last level of the clock tree structure, but the same advantageous effect can be obtained also in the case where the macro 504 is arranged between driving elements in any level in the clock tree structure.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention is applicable to clock supply circuits, and in particular to tree-structure clock supply circuits.

What is claimed is:

1. A clock supply circuit which has a clock tree structure and supplies a clock signal to operating elements, said circuit comprising:
driving elements arranged in levels in the clock tree structure; and
connection lines which connect output terminals of said driving elements either to input terminals of driving elements arranged in levels immediately succeeding the levels of said respective driving elements with which said respective connection lines start or to input terminals of the operating elements with which last ones of said connection lines end,
wherein said connection lines include:
first lines formed in a standard wiring layer; and
at least one second line formed above a circuit block which uses said standard wiring layer, and
wherein said at least one second line formed above the circuit block is in a predetermined wiring layer higher than said standard wiring layer.

2. The clock supply circuit according to claim 1,
wherein, in the clock tree structure, all connection lines formed in a level in which said second line is formed have at least one portion formed in said predetermined wiring layer.

3. The clock supply circuit according to claim 1,
wherein said second line is a connection line formed in a level lower than a middle level in the clock tree structure.

4. The clock supply circuit according to claim 1,
wherein said predetermined wiring layer is thicker than said standard wiring layer.

5. The clock supply circuit according to claim 1,
wherein the number of levels of said driving elements is the same in all paths, each of said paths starting with a driving element arranged in a highest level in the clock tree structure and ending with a corresponding one of the operating elements,
line lengths of said connection lines are approximately the same in the respective levels in the paths in the clock tree structure, and
driving performances of said driving elements are approximately the same in the respective levels in the clock tree structure.

6. A method for designing a clock supply circuit which has a clock tree structure and supplies a clock signal to operating elements, said method comprising:
forming, in the case where a connection line for connecting driving elements which is to be arranged in levels in the clock tree structure is formed above a circuit block which uses a standard wiring layer, said connection line in a predetermined wiring layer higher than the standard wiring layer; and
forming, in the case where a connection line for connecting driving elements which is to be arranged in levels in the clock tree structure is not arranged above the circuit block which uses the standard wiring layer, said connection line in the standard wiring layer.
